(19) United States
(12) Patent Application Publication
(10) Pub. No.: US 2004/0252323 A1
(43) Pub. Date: Dec. 16, 2004

(54) Image processing system and image scanning device

(75) Inventor: Katsushi Mimamino, Kyoto-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 10/783,214

(22) Filed: Feb. 20, 2004

(30) Foreign Application Priority Data
May 28, 2003 (JP) 2003-150090
May 29, 2003 (JP) 2003-152796

(51) Int. Cl. G06F 3/12; G06F 3/05; G06F 11/30; G06F 15/173; G06F 15/17

(52) U.S. Cl. 358/1.14; 358/1.15; 358/1.16; 709/239; 709/243; 710/19; 710/38; 710/52; 710/57

(57) ABSTRACT

An image processing system includes an image scanning device that outputs via a network, scanned image information obtained by scanning an image of an original document, an image output device that visibly outputs remote image information input from a remote device, and an information processing device that accepts an input of the scanned image information from the image scanning device and that outputs the scanned image information to the image output device. A hub connects the image scanning device, the image output device and the information processing device to the network so that data can be exchanged by a common protocol. The image scanning device includes a port for connecting the image output device, a port for connecting the information processing device and a controller that analyzes destination information of data input from the ports and switches connections of the ports in accordance with the destination information.

### BACKGROUND OF THE INVENTION

1. Field of the Invention

The present invention relates to an image processing system including a scanner device (image scanning device), a printer device (image output device) and a personal computer (information processing device), and to an image scanning device.

2. Description of the Related Art

As shown in FIG. 12, in a general image processing system, a scanner device 1 and a printer device 2 are connected to Personal Computers (PC)s 3, 4, 5, . . . via a Local Area Network (LAN) 6. For example, an image of an original document scanned by the scanner device 1 is transmitted to the printer device 2 via the PC 3, and a copying process is executed. As shown in FIG. 13, in another image processing system, a Multi Function Peripheral (MFP) 10 is connected to the PCs 3, 4, 5, . . . via the LAN 6. The MFP 10 includes an image scanning unit 10a, an image forming unit 10b, a control unit 10c and a network InterFace (I/F) 10d. For example, in accordance with a request from the PC 3, an image of an original document scanned by the image scanning unit 10a of the MFP 10 is forwarded to the PC 3, or data to be printed out is forwarded from the PC 3 to the MFP 10. Then, a printing process is executed by the image forming unit 10b.

In the conventional image processing system in which the scanner device 1 and the printer device 2 are connected to the PCs 3, 4, 5, . . . via the LAN 6, when executing the copying process, the scanned image data cannot be transmitted directly from the scanner device to the printer device and it is necessary to transmit the data via the PC.

There is, however, a system in which the scanner device, the printer device and the PC are connected to a repeater hub. However, since the repeater hub is used, when executing the copying process, the network load increases.

In the system shown in FIG. 13, since the scanner function and the printer function are common to the control unit 10c and the network I/F 10d, the structure of the control unit becomes complicated and it is difficult to easily change the image scanning unit and the image forming unit. Furthermore, in another system, instead of connecting the printer device 2 of FIG. 12 directly to the LAN 6, the printer device 2 may be connected to the LAN 6 via the scanner device 1. However, in this case, since data is exchanged between the PC and the printer device, it becomes difficult to control the scanner device.

### SUMMARY OF THE INVENTION

The present invention was made in consideration to the above-described circumstances. An advantage of the present invention is to provide an image processing system and an image scanning device which can implement a copying process without a PC, reduce a load placed on a network, simplify a structure of a control unit and easily change a scanner device and a printer device.

Another advantage of the present invention is to provide an image processing system and an image scanning device which include a scanner device, a printer device and a PC, and which execute both a PC printing process and a copying process without confusion even when there is a conflict of instructions for the PC printing and the copying process.

In the image processing system of the present invention, an image scanning device, an image output device and an information processing device are respectively connected to a network so that data can be exchanged by a common protocol. The image scanning device can output via the network, image information obtained by scanning an image of an original document. The image output device visibly outputs (records or displays) image information input from a remote device. The information processing device is a PC or the like, and the image information can be input from the image scanning device to the information processing device. The information processing device can output the image information to the image output device. According to an aspect of the present invention, the image scanning device includes a port for connecting the image output device, and a port for connecting the information processing device. The image scanning device also includes a control unit which analyzes destination information of the data input from the ports and controls to switch a connection between the ports in accordance with the destination information.

According to the present invention, since the image scanning device includes a switching hub function, the image scanning device, the image output device and the information processing device can be connected effectively to a network without preparing a switching hub separately. In addition, according to the present invention, since a PC becomes unnecessary for the copying process, a load placed on the network can be prevented from increasing. Furthermore, according to the present invention, the image scanning device or the printer can be changed easily.

For example, the control unit of the image scanning device includes a storage unit which stores destination information of the image scanning device. When data is input to a port for the image output device, the control unit analyzes the destination information included in the data. That is, the control unit determines whether the destination information is for the image scanning device or another device. When the destination information is for the image scanning device, the image scanning device retrieves the data inside. When the destination information is for another device, the image scanning device outputs the data to a port for the information processing device.

For example, the control unit of the image scanning device includes a storage unit which stores destination information of the image output device. When data is input to the port for the information processing device, the control unit analyzes the destination information included in the data. That is, the control unit determines whether the destination information is for the image scanning device, the image output device or another device. When the destination information is for the image scanning device, the image scanning device retrieves the data inside. When the destination information is for the image output device, the image scanning device transmits the data to the image output device. When the destination information is for another device, the image scanning device abandons the data.

For example, the control unit of the image scanning device temporarily stores in a buffer, the data input to the port for the information processing device. When the destination information is for the image output device, the image scanning device outputs the data to the port for the image output device. After outputting the data, when the image scanning device receives data indicating that the port for the image output device received the data normally, the image scanning device abandons the data.

For example, the control unit of the image scanning device stores a status of “not stored” or “stored” by associating to destination information (Media Access Control (MAC) address, etc.) with the connected device. An initial status (before a confirmation operation of the connected device) is a status of “not stored”. As the confirmation operation of the connected device, the control unit outputs confirmation data to the port for the image output device, and monitors whether or not a reception confirmation has been returned within a prescribed period of time. After outputting the confirmation data, when data corresponding to the reception confirmation is input to the port for the image output device within a prescribed period of time, the status of the device, which is a transmitter of the reception confirmation, changes to a “stored” status.

The control unit of the image scanning device includes a storage unit which stores destination information for permitting scanning of an image or destination information for not permitting the scanning of the image (destination information for rejecting). When an image scanning instruction is input from the port of the information processing device, the transmitter address is analyzed and compared with the stored destination information. In accordance with the result of the comparison, a determination is made as to whether or not to permit the image scanning instruction.

The control unit of the image scanning device includes a storage unit which stores destination information for permitting an image output or destination information for not permitting the image output (destination information for rejecting). When an image output instruction (printing request) is input from the port of the information processing device, the transmitter address is analyzed and compared with the stored destination information. In accordance with the result of the comparison, a determination is made as to whether or not to permit the image output instruction.

For example, the control unit of the image scanning device outputs confirmation data to the port of the information processing device, and monitors whether or not data corresponding to a reception confirmation is returned within a prescribed period of time. After outputting the confirmation data, in accordance with whether or not the data corresponding to the reception confirmation is input to the port for the information processing device within a prescribed period of time, the control unit switches a connection status of the port section.

In the image processing system of the present invention, an image scanning device, an image output device and an information processing device are respectively connected to a network so that data can be exchanged. The image scanning device can output via the network, image information obtained by scanning an image of an original document. The image output device visibly outputs (records or displays) image information input from a remote device. The information processing device is a PC or the like, and the image information can be input from the image scanning device and sent to the information processing device. The information processing device can output the image information to the image output device.

According to an aspect of the present invention, the image scanning device includes a first port for connecting the image output device and a second port for connecting the information processing device, and executes the following control process. When executing a copying process, the image scanning device outputs the image information from the first port via the network to the image output device. During the copying process, when the image scanning device receives a network printing request (PC printing request) from the network through the second port, the image scanning device receives and accumulates print data until an inner storage unit reaches a prescribed accumulation amount. For example, the print data is accumulated for each page. When the inner storage unit reaches the prescribed accumulation amount, the image scanning device transmits to the information processing device, which is a transmitter, data indicating a fact that the transmission of the print data should be interrupted or suppressed. When the copying process ends, the printing of the accumulated print data starts. In addition, the image scanning device requests the information processing device to transmit the print data that failed to be transmitted due to the interruption or the suppression of the transmission.

According to the present invention, an external switching hub is not used. Therefore, even during the copying process, the image scanning device can accept the print data from the PC for an amount that can be accumulated in the image scanning device.

According to the present invention, the print data from the PC can be buffered in the memory of the image scanning device, and it is not necessary to add memory to the printer device. As a result, the memory of the image scanning device can be used effectively, and the structure of the printer device can be simplified.

According to an aspect of the present invention, the image scanning device includes a first port for connecting the image output device and a second port for connecting the information processing device, and executes the following control process. When executing a network printing process, the image scanning device outputs from the first port via the network to the image output device, the print data received via the network by the second port. When a copying instruction is input during the network printing process, the image scanning device scans an image and accumulates the scanned image data until the inner storage unit reaches a prescribed accumulation amount. When the inner storage unit reaches the prescribed accumulation amount, the image scanning unit stops the scanning process or decreases a scanning speed. As the network printing process progresses, when available capacity in the inner storage unit recovers, the image scanning device restarts the scanning process or increases the scanning speed. When the network printing process ends, the image scanning device outputs the accumulated scanned image data from the first port via the network to the image output device.

When the inner storage unit reaches the prescribed accumulation amount, the image scanning device stops the scanning process or decreases the scanning speed. This process includes a case where threshold values are stored for a plurality of stages and when a first threshold value has been reached, the scanning speed is decreased and when a second threshold value has been reached, the scanning process stops.

For example, the image scanning device includes an operation unit having a key for instructing an interrupt copy. When the interrupt copy key is operated during the network printing process, the network printing process can be interrupted. Accompanying the interruption of the network printing process, the image scanning device proceeds to the status to accept an input of a copy condition by a user. Under the status to accept the copy condition, after the copy condition is input and set, when an instruction to start a copying process is input, the copying process is started. Further, when the copy condition can be input and set before operating the interrupt key, if the interrupt key is operated, the network printing process can be interrupted and the copying process can be started.

For example, the control unit of the image scanning device includes a setting unit which sets to execute one of the copying process and the network printing process preferentially. When there is a conflict between the copying process and the network printing process, the process, which is set by the setting unit to be executed preferentially, is executed preferentially.

### BRIEF DESCRIPTION OF THE DRAWINGS

FIG. 1 is a block diagram showing a configuration of an image processing system according to an embodiment of the present invention.

FIG. 2 is a block diagram showing a schematic configuration of a scanner device.

FIG. 3 is a flowchart showing a process carried out by the scanner device when data is input from a printer connecting port.

FIG. 4 is a flowchart showing a process carried out by the scanner device when data is input from a PC connecting port.

FIG. 5 is also a flowchart showing the process carried out by the scanner device when the data is input from the PC connecting port.

FIG. 6 is a flowchart showing a process carried out by the scanner device when there is a scanning instruction and/or a printing instruction from the PC connecting port.

FIG. 7 is a flowchart showing a process carried out by the scanner device when executing a port connection switching function of the PC connecting port.

FIG. 8 is a flowchart showing a process carried out by the scanner device when executing a copying process.

FIG. 9 is a flowchart showing a process carried out by the scanner device when receiving a PC printing request from a PC.

FIG. 10 is a flowchart showing a process carried out by the scanner device when a copying instruction is input during the PC printing process.

FIG. 11 is a flowchart showing a process carried out by the scanner device after the copying process or the PC printing process has ended.

FIG. 12 is a block diagram showing a schematic configuration of a conventional image processing system.

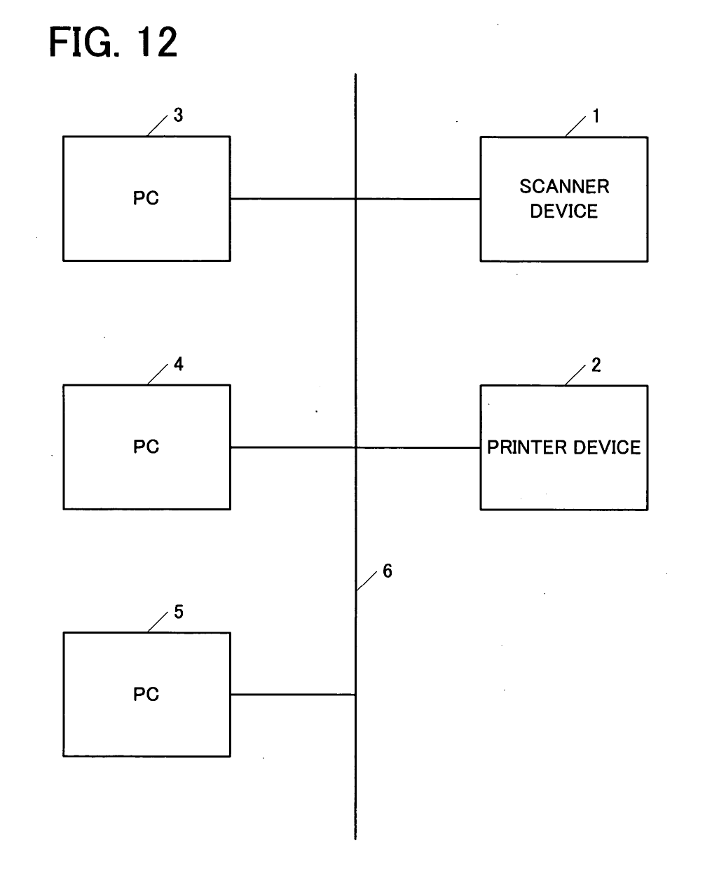

FIG. 13 is a block diagram showing a schematic configuration of another conventional image processing system.

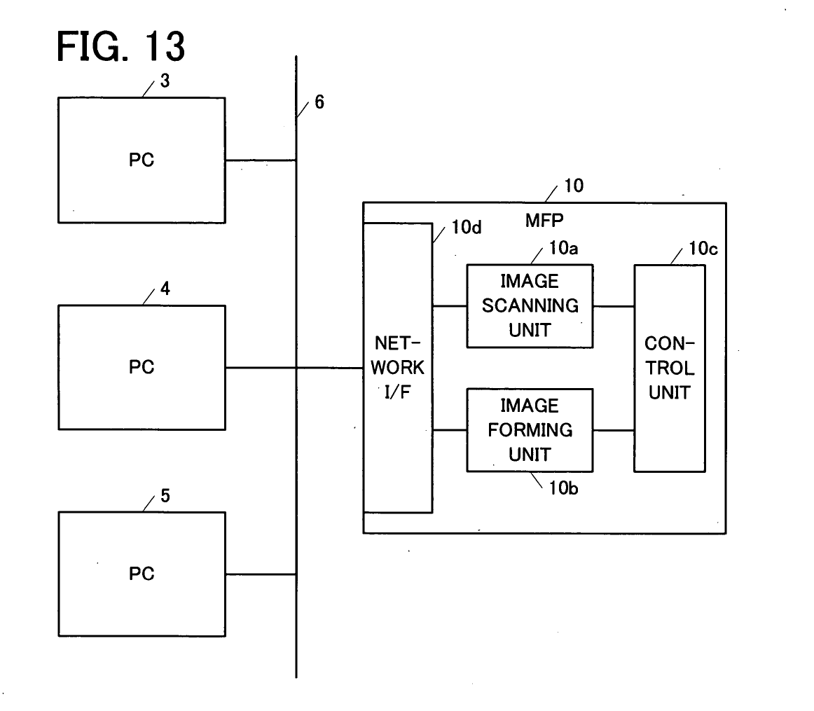

### DETAILED DESCRIPTION OF THE PREFERRED EMBODIMENTS

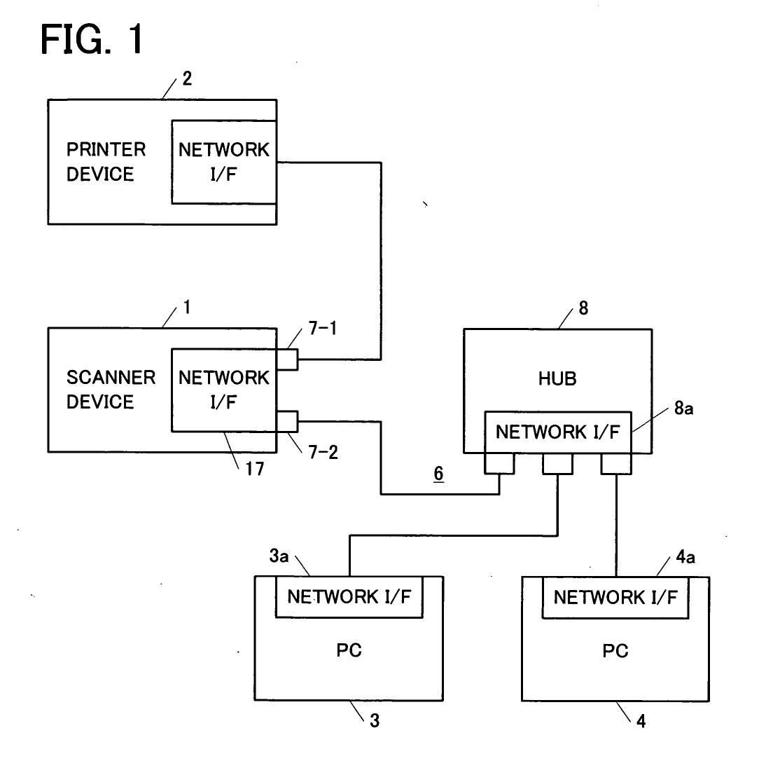

Embodiments of the present invention will be described in detail. FIG. 1 is a block diagram showing a configuration of an image processing system according to an embodiment of the present invention. The image processing system according to the embodiment includes a scanner device (image scanning device) 1 which scans an image of an original document, a printer device (image output device) 2 and PCs (information processing devices) 3 and 4. The scanner device 1, the printer device 2 and the information processing devices 3 and 4 are respectively connected to a network so that data can be exchanged by a common protocol.

The scanner device 1 includes an output unit to output via the network, image information obtained by scanning the image of the original document. The printer device 2 visibly outputs (records) image information input from a remote device. The image information can be input from the scanner device 1 to the PCs 3 and 4. The PCs 3 and 4 can output the image information to the printer device 2.

The scanner device 1 includes a printer connecting port 7-1 and a PC connecting port 7-2. The printer device 2 is connected to the printer connecting port 7-1 of the scanner device 1 via a communication cable. The PC 3 is connected to the PC connecting port 7-2 of the scanner device 1 by a Local Area Network (LAN) 6. The PC connecting port 7-2 of the scanner device 1 is connected to an input/output port of a hub 8 via a LAN cable. The PCs 3 and 4 are also connected to input/output ports of the hub 8 via LAN cables respectively. The scanner device 1 and the PCs 3 and 4 are connected to different input/output ports of the hub 8 respectively. The scanner device 1, the hub 8 and the PCs 3 and 4 constitute the LAN.

The printer device 2 and the PCs 3 and 4 in the network are individually assigned with address information (Media Access Control (MAC) address) as destination information. The scanner device 1 stores destination information (MAC address) of a device to be connected to the printer connecting port 7-1. However, the scanner device 1 does not store the destination information (MAC address) of a device to be connected to the other port 7-2. That is, the scanner device 1 stores the destination information of only the device to be connected to the printer connecting port 7-1. Further, other than the MAC address, the destination information can be information indicating a scanner device or a printer device.

In the image processing system, a common communication protocol is used for each of the network devices. That is, between the scanner device 1 and the printer device 2, between the scanner device 1 and the hub 8, and between the hub 8 and the PCs 3 and 4, data communication is executed by a common protocol.

As it is evident from FIG. 1, the printer device 2 is connected directly to only the scanner device 1. The printer device 2 is not connected directly to other devices such as the hub 8 and the PCs 3 and 4. That is, the printer device 2 is connected to the hub 8 or the PCs 3 and 4 via the scanner device 1. Therefore, the data communication between the printer device 2 and the PCs 3 and 4 is carried out via the scanner device 1. Due to such a configuration, a port for connecting the PCs 3 and 4 or the hub 8 becomes unnecessary in the printer device 2. Since the hub 8 and the printer device 2 are not connected directly, a number of ports of the hub 8 can be reduced.

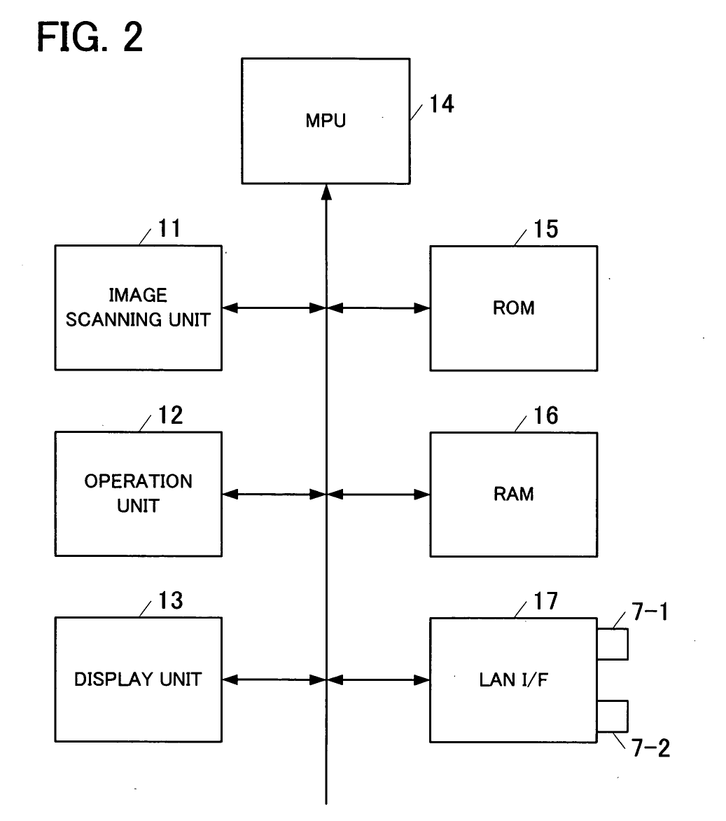

As shown in FIG. 2, the scanner device 1 includes an image scanning unit 11, an operation unit 12, a display unit 13, a Micro Processing Unit (MPU) 14, a Read Only Memory (ROM) 15, a Random Access Memory (RAM) 16 and a network I/F 17. The image scanning unit 11 includes a color scanning function, and generates scanned image data by scanning an image of an original document. The operation unit 12 includes a copy key, an interrupt copy key, a ten-key numeric pad and other operation keys. By operating the keys of the operation unit 12, a user can input various instructions. The display unit 13 is formed of a Liquid Crystal Display (LCD) or the like and displays various messages. In accordance with a program stored in the ROM 15, the MPU 14 executes various control processes including a process relating to scanning of an image to be described later. The ROM 15 stores a program to be executed by the MPU 14. The RAM 16 stores temporary buffer data or scanned image data that are generated when the program is executed. The network I/F 17 includes the ports 7-1 and 7-2, and carries out data communication with another network device via the ports 7-1 and 7-2.

In the example shown in FIG. 1, the scanner device 1 includes one port 7-1 exclusive for the printer device. However, in another embodiment, a plurality of ports exclusive for printer devices can be provided to the scanner device 1, and a plurality of printer devices can be connected directly to the scanner device 1.

The scanner device 1 converts electric signals (analog signals) input to each of the ports 7-1 and 7-2 into digital signals, and analyzes the destination information in accordance with the digital signals. Then, in accordance with the result of the analysis, the scanner device 1 controls whether to retrieve the input data inside or to output the input data as the electric signals by selecting a prescribed output port.

As a result of analyzing the destination information for the input data, when the input data is not the data to be retrieved inside, in other words, when the scanner device 1 is not included in the destination information, the scanner device 1 forwards the data to a prescribed port without analyzing the contents of the data. For example, when the scanner device 1 receives data from the PCs 3 and 4, the scanner device 1 analyzes the destination information for the received data, but does not analyze the contents of the request. Therefore, it is not necessary for the scanner device 1 to return status information stored in the scanner device 1 as a response to the request for printer status information from the PCs 3 and 4. Accordingly, even when the PCs 3 and 4 frequently request the printer status information, increased loads placed on processes to be carried out by the scanner device 1 can be suppressed. The printer status information is information indicating status of the developer (for example, toner) and/or recording paper.

Further, the PCs 3 and 4 request the printer status information at least when executing the network printing process (PC printing process), in other words, when transmitting the print data from the PCs 3 and 4 to the printer device 2. The PCs 3 and 4 can request the printer status information from the printer device 2, including the time when not executing the network printing process. The network printing process is a process in which the print data is transmitted from the PCs 3 and 4 via the network to the printer device 2 and the printer device 2 executes the printing process based on the print data.

The scanner device 1 periodically transmits to the printer device 2, data requesting transmission of the printer status information. That is, the scanner device 1 is always monitoring the status of the printer device 2. Instead of periodically requesting automatically, or in addition to periodically requesting automatically, when a user performs a prescribed operation (for example, an instruction to start copying), the scanner device 1 can request the printer device 2 to transmit the printer status information.

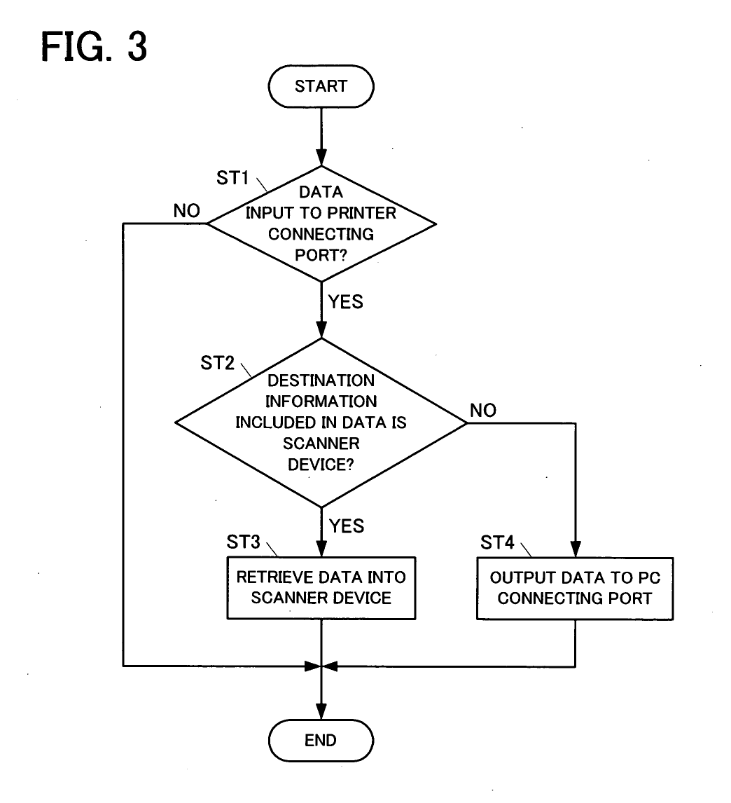

The data input from the ports 7-1 and 7-2 of the scanner device 1 includes address information of a transmitter and address information of a destination (destination information). FIG. 3 is a flowchart showing a process carried out by the scanner 1 when data has been input to the printer connecting port 7-1. When entering a routine shown in FIG. 3, at step ST1, a determination is made as to whether or not data has been input to the printer connecting port 7-1. When the data has been input to the printer connecting port 7-1, the process proceeds to step ST2. At step ST2, header information of the input packet data is analyzed, and a determination is made as to whether or not the destination information is the scanner device 1. When the destination information is the scanner device 1, the process proceeds to step ST3. Meanwhile, when the destination information is not the scanner device 1, the process proceeds to step ST4. At step ST3, the scanner device 1 retrieves the data inside and does not transmit the data to the PC connecting port 7-2. At step ST4, the scanner device 1 does not retrieve the data inside and transmits the data to the PC connecting port 7-1.

In the present embodiment, the ports 7-1 and 7-2 of the scanner device 1 are unlike a normal switching hub that holds a table showing a correspondence between the destination information and the port. The ports 7-1 and 7-2 just determine whether the destination information is the scanner device 1 or another device. When the destination information is a device other than the scanner device 1, the destination information is not determined for recognizing the particular device. Accordingly, it becomes unnecessary to store the address information of a device connected to the PC connecting port 7-2, and a structure and a control of the scanner device 1 becomes simple.

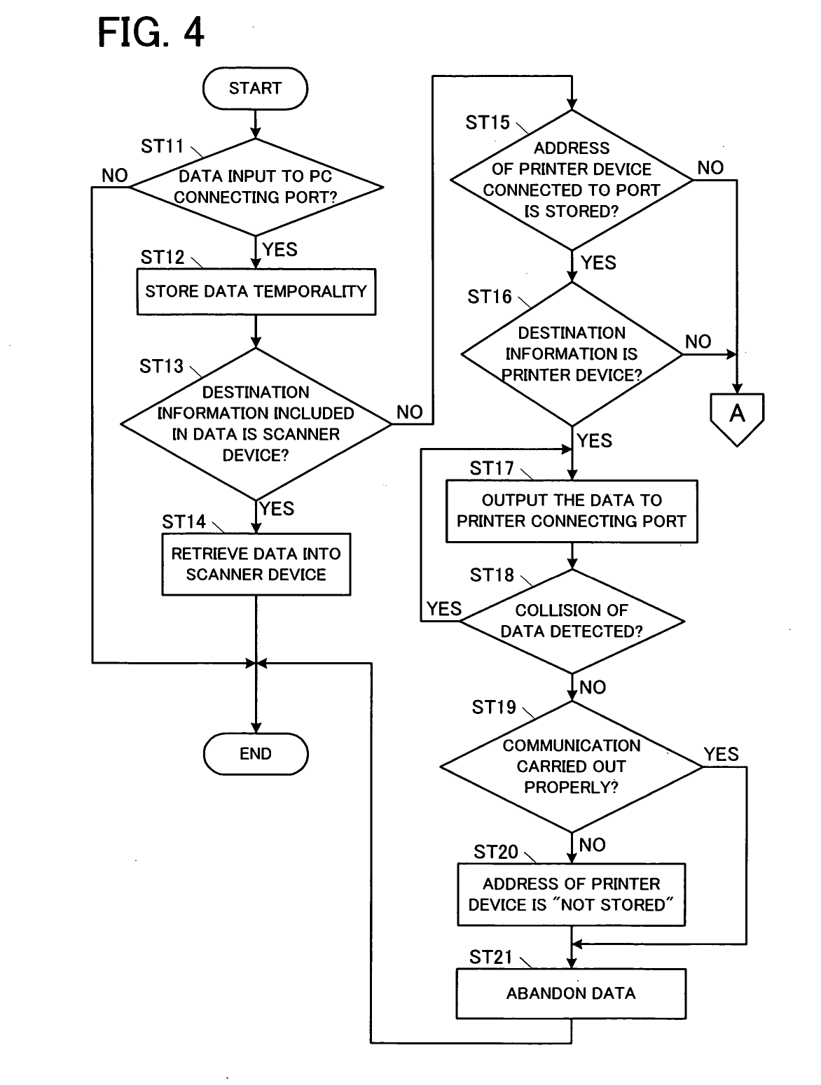

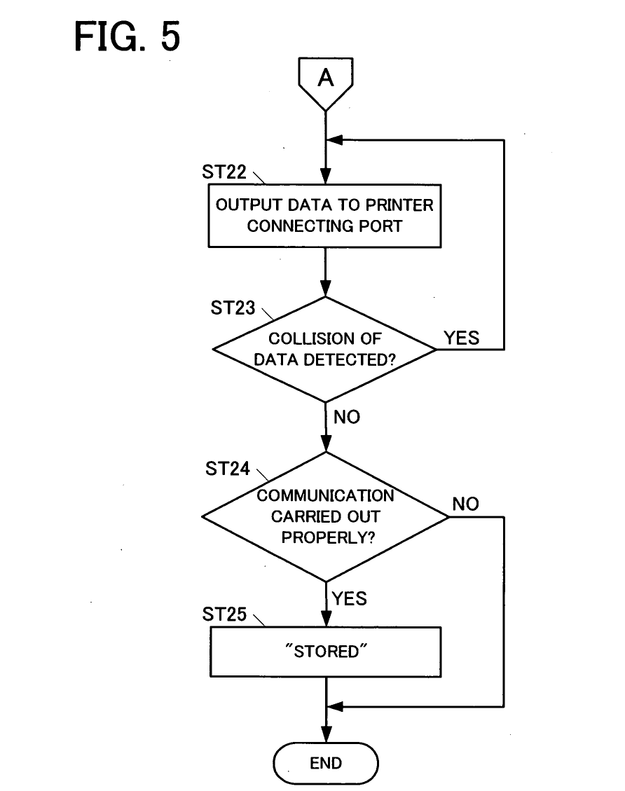

FIGS. 4 and 5 are flowcharts showing a process carried out by the scanner device 1 when data has been input to the PC connecting port 7-2. When entering the routine shown in FIG. 4, at step ST11, a determination is made as to whether or not data has been input to the PC connecting port 7-2. When it is determined that the data has been input to the PC connecting port 7-2, the process proceeds to step ST12. At step ST12, the input data has been stored temporarily in a buffer memory of the RAM 16.

Next, the process proceeds to step ST13. At step ST13, a determination is made as to whether or not the destination information included in the input data is the scanner device 1. When the destination information is the scanner device 1, the process proceeds to step ST14. Meanwhile, when the destination information is not the scanner device 1, the process proceeds to step ST15. At step ST14, the input data is retrieved inside.

At step ST15, a determination is made as to whether or not address information of the printer device connected to the printer connecting port 7-1 has been stored. When the address information of the printer device connected has been stored, the process proceeds to step ST16. Meanwhile, when the address information of the printer device connected has not been stored, the process proceeds to step ST22 (FIG. 5).

At step ST16, a determination is made as to whether or not the destination information is the printer device 2. When the destination information is the printer device 2, the process proceeds to step ST17. At step ST17, the input data is output to the printer connecting port 7-1. Next, the process proceeds to step ST18, and a determination is made as to whether or not a collision of the data has been detected. When the collision of the data has been detected, the process returns to step ST17, and the data is output again to the port 7-1.

Meanwhile, when the collision of the data has not been detected, the process proceeds to step ST19. At step ST19, a determination is made as to whether or not the communication has been carried out properly. That is, a determination is made as to whether or not the data corresponding to the reception confirmation has been input to the printer connecting port 7-1 within a prescribed period of time. When the communication has been carried out properly, the process proceeds to step ST21, and the data stored in the buffer memory is abandoned. When the communication has failed to be carried out properly, the process proceeds to step ST20. At step ST20, the address information of the address memory for the printer device 2 is changed to a “not stored” status. In the address memory, the status of the address information (destination information), “stored” or “not stored”, is stored by being associated with the printer connecting port.

At step ST22, the input data is output to the printer connecting port 7-1. Then, the process proceeds to step ST23. At step ST23, a determination is made as to whether or not a collision of the data has been detected. When the collision of the data has been detected, the process returns to step ST22, and the input data is output again to the port 7-1. Meanwhile, when the collision of the data has not been detected, the process proceeds to step ST24. At step ST24, a determination is made as to whether or not the communication has been carried out properly. That is, a determination is made as to whether or not the data corresponding to the reception confirmation has been input to the printer connecting port 7-1 within a prescribed period of time. When the communication has been carried out properly, the process proceeds to step ST25. At step ST25, the destination information for the port 7-1 changes to the “stored” status in the address memory. Meanwhile, when the communication has failed to be carried out properly, the process ends.

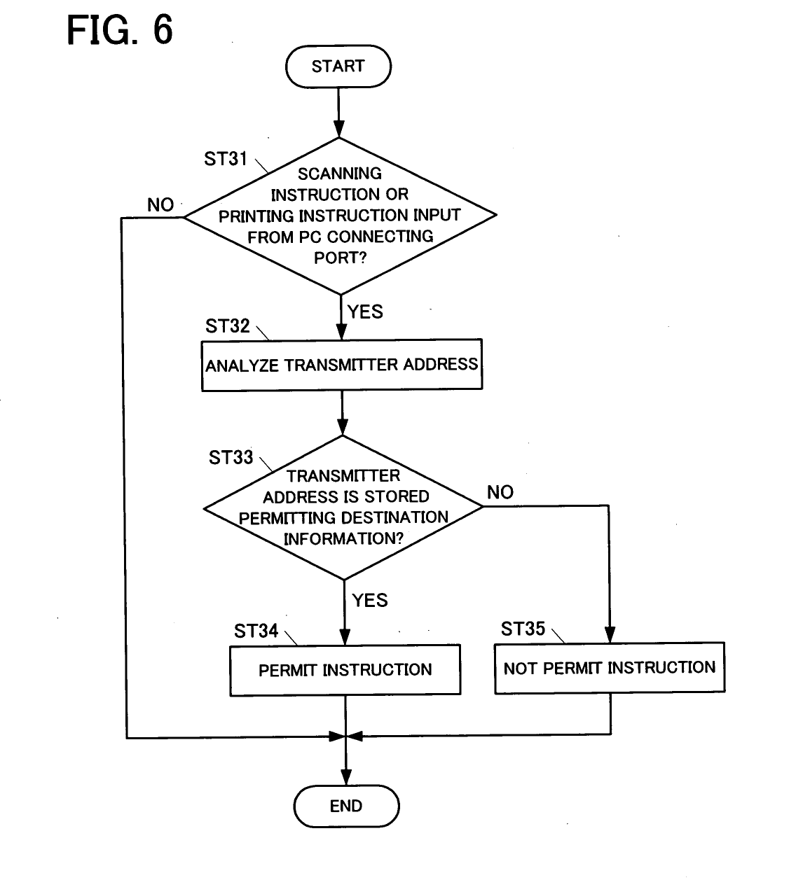

The scanner device 1 also includes a memory for storing destination information for permitting PC scanning and/or PC printing. In place of the destination information for permitting, or in addition to the destination information for permitting, destination information for not permitting can be stored. FIG. 6 is a flowchart showing a process carried out by the scanner device 1 when a scanning instruction and/or a printing instruction is input from the PCs 3 and 4.

In FIG. 6, at step ST31, a determination is made as to whether or not a scanning instruction and/or a printing instruction has been input from the PC connecting port 7-2. When either the scanning instruction or the printing instruction has been input, the process proceeds to step ST32. At step ST32, a transmitter address included in header information of the input data is analyzed. Next, the process proceeds to step ST33. At step ST33, a determination is made as to whether or not the transmitter address has been included in the stored permitting address information. When the transmitter address has been included in the permitting destination information, the process proceeds to step ST34. Meanwhile, when the transmitter address has not been included in the permitting destination information, the process proceeds to step ST35. At step ST34, the input instruction is permitted. At step ST35, the input instruction is not permitted.

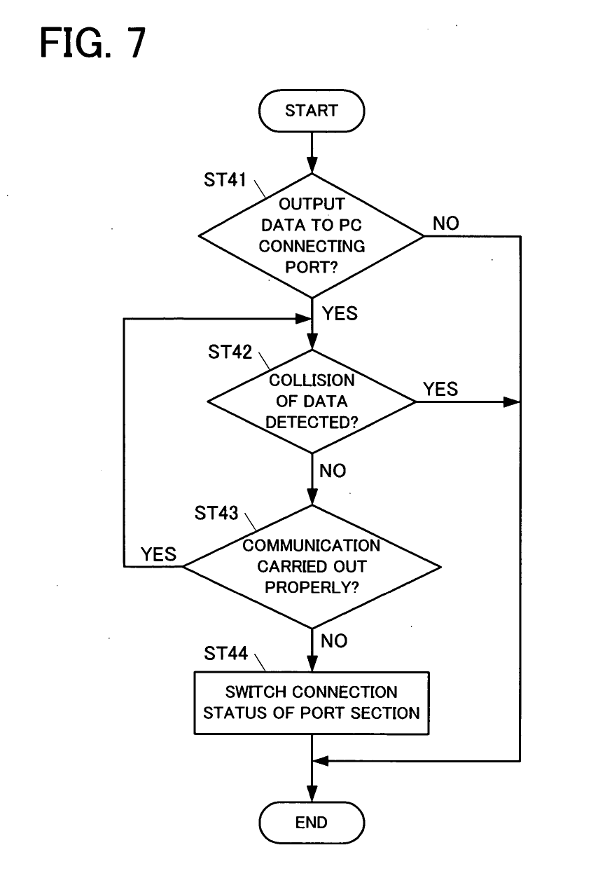

The scanner device 1 includes a port connection switching function for the PC connecting port 7-2. The port connection switching function will be described with reference to FIG. 7. When entering the routine shown in FIG. 7, at step ST41, a determination is made as to whether or not data has been output to the PC connecting port 7-2. When the data has been output, the process proceeds to step ST42. Meanwhile, when the data has not been output, the process ends. At step ST42, a determination is made as to whether or not a collision of the data has been detected. When there has been no collision of the data, the process proceeds to step ST43. At step ST43, a determination is made as to whether or not the communication has been carried out properly. That is, a determination is made as to whether or not the data corresponding to the reception confirmation has been input to the PC connecting port 7-2 within a prescribed period of time. When the communication has been carried out properly, the process proceeds to step ST42. Meanwhile, when the communication has failed to be carried out properly, the process proceeds to step ST44.

At step ST44, the connection status of the port section switches. For example, the connection status of the port section switches between a signal line for transmission and a signal line for reception. In this case, it is not necessary to distinguish usage of a cross cable and a straight cable for when the hub 8 is connected to the PC connecting port 7-1 (when a plurality of PCs are connected) and when a PC is connected directly to the PC connecting port 7-2 (when one PC is connected).

Further, in the above-described image processing system, data is transmitted and received between the scanner device 1, the printer device 2 and the PC 3 by packet switching. The scanner device 1 accumulates all of one packet of data once and then outputs the packet of data to a destination. Therefore, even when communication speed differs for each port, there is no inconvenience. That is, even when the communication speed between the scanner device 1 and the printer device 2 and the communication speed between the scanner device 1 and the PC 3 are different, data communication can be carried out without receiving any restrictions.

When a plurality of ports are provided for connecting the printer device 2 directly to the scanner device 1, a part of the ports can be for color and the remaining ports can be for monochrome. A color printer device can be connected to the port for color and a monochrome printer device can be connected to the port for monochrome. In this case, the scanner device 1 stores attributes (color or monochrome) of the printer device for each port as the destination information. Accordingly, at the network printing process, the attributes described in the data received from the PC can be analyzed, and the output port can be selected in accordance with the result of the analysis. At the copying process, in accordance with the attributes (color copy or monochrome copy) set from the operation unit, the output port of the scanned image data can be selected.

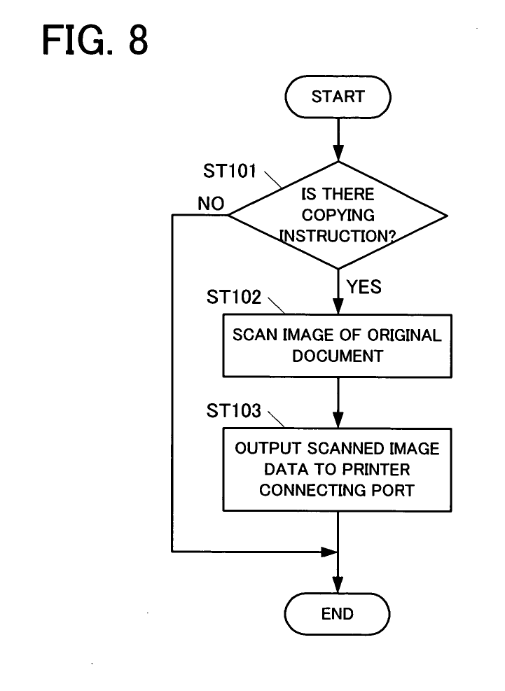

Next, referring to FIG. 8, a process carried out by the scanner device 1 when a copying instruction is input by the operation unit 12 will be described. At step ST101, a determination is made as to whether or not a copying instruction has been input. When the copying instruction has been input, the process proceeds to step ST1O2. At step ST102, the image scanning unit 11 scans an image of an original document. Then, the process proceeds to step ST103. At step ST103, the scanned image data is output from the printer connecting port 7-1. The printer device 2 receives the scanned image data from the printer connecting port 7-1 of the scanner device 1 and executes a printing process. The copying process is implemented as described above.

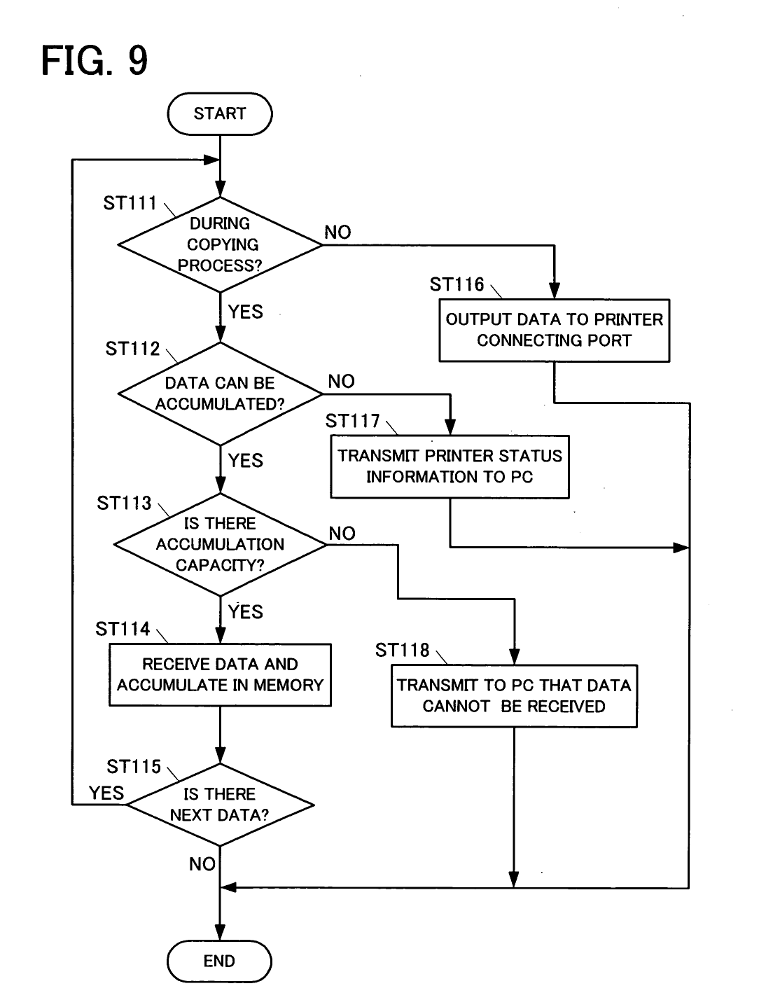

FIG. 9 shows a process carried out by the scanner device 1 when there is a request to start communication from the PC connecting port 7-2 during the copying process of FIG. 8. When there is a request to start the communication from the PC connecting port 7-2, at step ST111, a determination is made as to whether or not the copying process is being carried out. When the copying process is being carried out, the process proceeds to step ST112. Meanwhile, when the copying process is not being carried out, the process proceeds to step ST116. At step ST116, the data is forwarded to the printer connecting port 7-2.

At step ST112, a determination is made as to whether or not the data transmitted from the PC 3 or the like is data that can be accumulated. When the data from the PC 3 is print data, the print data is determined to be data that can be accumulated. In this case, the process proceeds to step ST113. Meanwhile, when the data from the PC 3 or the like is a request for the printer status information, since the data is not necessary to be accumulated, the data is determined to be data that cannot be accumulated. In this case, the process proceeds to step ST117. At step ST117, the status is transmitted to the PC 3.

At step ST113, a determination is made as to whether or not there is accumulation capacity in the memory of the scanner device 1. When there is accumulation capacity, the process proceeds to step ST114. Meanwhile, when there is a shortage of the accumulation capacity, the process proceeds to step ST118. At step ST118, a destination party of the communication (PC 3) is notified that the scanner device 1 cannot receive the data (interruption instruction) or that there is not enough accumulation capacity (suppression instruction). In case of the shortage of the accumulation capacity, when the accumulation capacity is a prescribed amount or less, a fact that the data cannot be received (interruption instruction) is notified, and when the accumulation capacity is a prescribed amount or more, a fact that there is not enough accumulation capacity (suppression instruction) is notified. When receiving the interruption instruction, the PC 3 interrupts transmission of the print data to the scanner device 1. When receiving the suppression instruction, the PC 3 decreases the transmission speed of the print data transmitted to the scanner device 1.

At step ST114, the data is received from the port 7-2, and the received data is accumulated in the inner memory. Next, the process proceeds to step ST115. At step ST115, a determination is made as to whether or not there is next data. When there is next data, the process returns to step ST111. When there is no next data, the process ends.

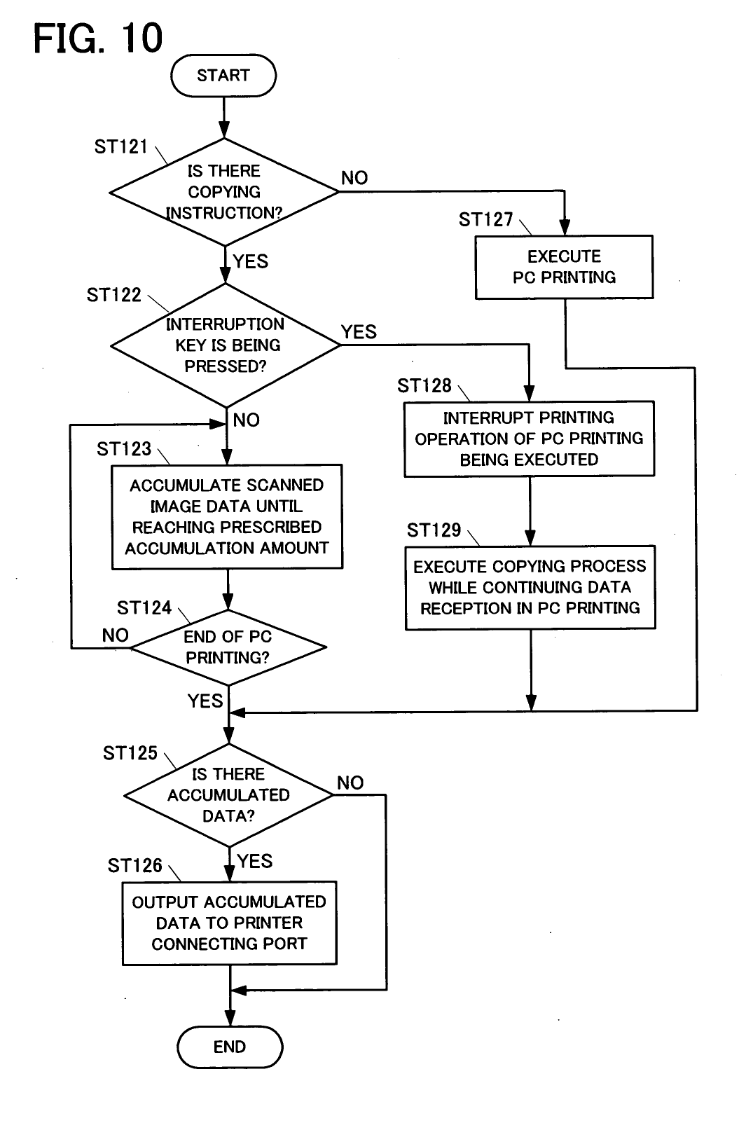

FIG. 10 shows a process carried out by the scanner device 1 when a copying instruction is input during the PC printing process. That is, FIG. 10 shows the process carried out when the copying instruction is input from the operation unit 12 while the print data received from the PC is forwarded to the printer device 2 (during the PC printing process). First, at step ST121, a determination is made as to whether or not the copying instruction has been input. When the copying instruction has been input from the operation unit 12, the process proceeds to step ST122. When the copying instruction has not been input, the process proceeds to step ST127 and the PC printing process is executed. At step ST122, a determination is made as to whether or not the interrupt key has been pressed. When the interrupt key has been pressed, the process proceeds to step ST128. Meanwhile, when the interrupt key has not been pressed, in other words, when the copying instruction does not accompany the operation of the interrupt key, the process proceeds to step ST123.

At step ST128, the printing operation of the PC printing process (forwarding of the data to the printer device 2) that is being executed is interrupted. The interruption of the printing operation is carried out in units of pages. That is, at the end of a page that is currently being forwarded, the forwarding of the print data to the printer device 2 is interrupted. Then, the process proceeds to step ST129. At step ST129, while continuing the data reception in the PC printing process, the copying process is executed. That is, while continuing to receive and accumulate the data from the PC in the PC printing process, the image is scanned and accumulated in the copying process. Accordingly, when there is a conflict with the copying process and the PC printing process, a process can be carried out efficiently. Next, the process proceeds to step ST125.

At step ST123, until reaching the prescribed accumulation amount, the scanned image data in the copying process is accumulated. Reaching the prescribed accumulation amount can be the available capacity in the memory reaching zero or approximately zero. Reaching the prescribed accumulation amount can also be the available capacity reaching one page, or one line or less. Next, the process proceeds to step ST124. At step Stl24, a determination is made as to whether or not the PC printing process has ended. When the PC printing process has not ended, the process returns to step ST123, and the scanned image data continues to be accumulated. Meanwhile, when the PC printing has ended, the process proceeds to step ST125.

At step ST125, a determination is made as to whether or not there is data that is accumulated in the memory. When there is no accumulated data, the process ends. Meanwhile, when there is accumulated data, the process proceeds to step ST126. At step ST126, the accumulated data is output to the printer connecting port 7-1. At step ST126, when there exist the data for the copying process (scanned image data) and the data for the PC printing process (print data received from the PC) as the accumulated data, the data for the copying process is output to the printer connecting port 7-1 preferentially.

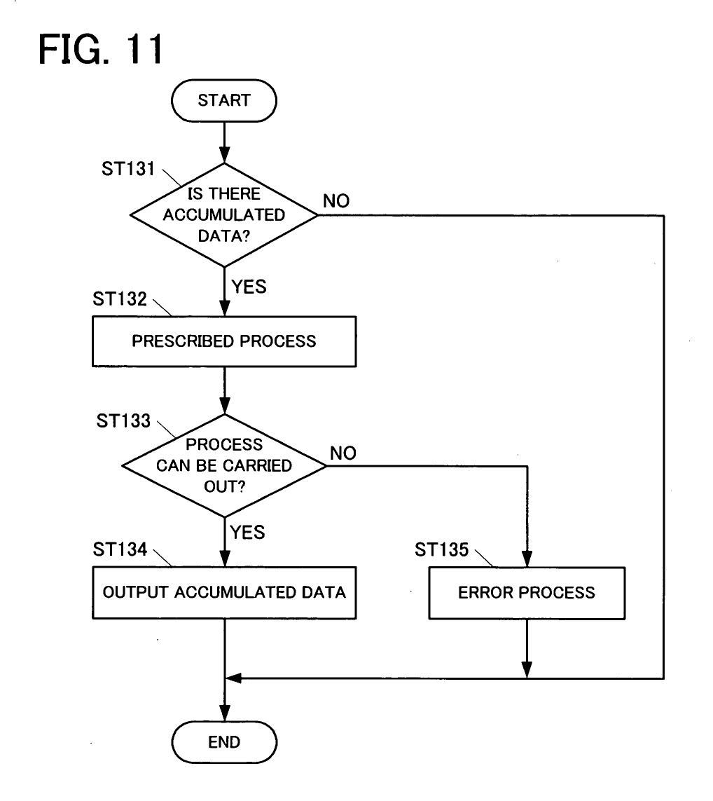

When the copying process or the PC printing process has ended, the scanner device 1 can execute a process shown in FIG. 11. In the routine shown in FIG. 11, at step ST131, a determination is made as to whether or not data is accumulated in the inner memory. When there is no accumulated data, the process ends. Meanwhile, when there is accumulated data, the process proceeds to step ST132. At step ST132, a prescribed process is executed. For example, here, a process that is necessary to be carried out prior to the output of the accumulated data from the printer connecting port 7-1 is executed. For example, when the accumulated data is the print data for the PC printing process, prior to the output of the print data, the scanner device 1 requests the printer status information from the printer device 2 and obtains the printer status information from the printer device 2. Then, the process proceeds to step ST133.

At step ST133, a determination is made as to whether or not a process can be carried out. For example, contents of the printer status information are analyzed, and a determination is made as to whether or not the print data can be printed. As the printer status information, when obtaining the fact that there is no developer, no paper or there is a paper jam, it is determined that the print data cannot be printed out, and the process proceeds to step ST135. At step ST135, a prescribed error process, such as outputting an alarm signal, is executed.

Meanwhile, when it is determined that the process can be carried out, in other words, as the printer status information, when not obtaining the fact that there is no developer, no paper or there is a paper jam, the process proceeds to step ST134. At step ST134, the accumulated data is output to the printer connecting port 7-1 and the accumulated data is transmitted to the printer device 2.

What is claimed is:

1. An image processing system comprising:
an image scanning device that outputs via a network, scanned image information obtained by scanning an image of an original document;
an image output device that visibly outputs remote image information input from a remote device;
an information processing device that accepts an input of the scanned image information from the image scanning device and that outputs the scanned image information to the image output device; and
means for connecting the image scanning device, the image output device and the information processing device to the network so that data can be exchanged by a common protocol;
wherein the image scanning device comprises:
a port for connecting the image output device;
a port for connecting the information processing device; and
means for controlling to analyze destination information of data input from the ports and to switch connections of the ports in accordance with the destination information.

2. An image scanning device comprising:
means for scanning an image;
means for outputting via a network, scanned image information obtained by scanning the image of an original document;
a port for connecting an image output device that visibly outputs remote image information input from a remote device;
a port for connecting an information processing device that accepts an input of the scanned image information from the image scanning device and that outputs the scanned image information to the image output device;
a data exchanging protocol that exchange data between the image output device and the information processing device by a common protocol; and
means for controlling to analyze destination information of data input from the ports and to switch connections of the ports in accordance with the destination information.

3. The image scanning device according to claim 2, wherein the means for controlling comprises:
means for storing the destination information of the image scanning device;
means for determining whether the destination information included in the data input to the port for the image output device is the image scanning device or a device other than the image scanning device; and
means for retrieving the data inside when the destination information is the image scanning device and outputting the data to the port for the information processing device when the destination information is the device other than the image scanning device.

4. The image scanning device according to claim 2, wherein the means for controlling comprises:
means for storing the destination information of the image output device;
means for determining whether the destination information included in the data input to the port for the information processing device is the image scanning device, the image output device or other device; and
means for retrieving the data inside when the destination information is the image scanning device, transmitting the data to the image output device when the destination information is the image output device, and abandoning the data when the destination information is for other devices.

5. The image scanning device according to claim 4, wherein the means for controlling comprises:
a buffer that temporarily stores the data input to the port for the information processing device; and
means for outputting the data to the port for the image output device when the destination information is the image output device, and after receiving data indicating a fact that the data has been received normally at the port for the image output device, abandoning the data.

6. The image scanning device according to claim 2, wherein the means for controlling comprises:
means for storing a status of “stored” or “not stored” by associating the status to the destination information of a device connected to the port for the image output device;
wherein an initial status is the “not stored” status, and when data is output to the port for the image output device and data corresponding to a reception confirmation is input to the port for the image output device within a prescribed period of time, the status changes to the “stored” status.

7. The image scanning device according to claim 2, wherein the means for controlling comprises:
means for storing the destination information for permitting scanning of an image and/or outputting of an image or destination information for not permitting the scanning of the image and/or the outputting of the image; and
means for analyzing a transmitter address when an image scanning instruction and/or an image output instruction is input from the port for the information processing device, comparing the transmitter address with the stored destination information and determining whether or not to permit the instructions.

8. The image scanning device according to claim 2, wherein the means for controlling comprises means for outputting data to the port for the information processing device, and switching connection status of a port section in accordance with whether or not data corresponding to a reception confirmation is input to the port for the information processing device within a prescribed period of time.

9. An image processing system comprising:
an image scanning device that outputs via a network, scanned image information obtained by scanning an image of an original document;
an image output device that visibly outputs remote image information input from a remote device;
an information processing device that accepts an input of the scanned image information from the image scanning device and that outputs the scanned image information to the image output device; and
means for connecting the image scanning device, the image output device and the information processing device to the network so that data can be exchanged;
wherein the image scanning device comprises:
a first port for connecting the image output device;
a second port for connecting the information processing device; and
means for controlling to output scanned image information from the first port via the network to the image output device in a copying process, and when receiving a network printing request from the network through the second port during the copying process, to receive and accumulate print data until a means for storing reaches a prescribed accumulation amount, and when the means for storing reaches the prescribed accumulation amount, to transmit to the information processing device, data instructing to interrupt or suppress transmission of the print data.

10. An image processing system comprising:
an image scanning device that outputs via a network, scanned image information obtained by scanning an image of an original document;
an image output device that visibly outputs remote image information input from a remote device;
an information processing device that accepts an input of the scanned image information from the image scanning device and that outputs the scanned image information to the image output device; and
means for connecting the image scanning device, the image output device and the information processing device to the network so that data can be exchanged;
wherein the image scanning device comprises:
a first port for connecting the image output device;
a second port for connecting the information processing device; and
means for controlling to output from the first port via the network to the image output device, print data received from the network through the second port in a network printing process, and when a copying instruction is input during the network printing process, to scan an image and to accumulate scanned image data until a means for storing reaches a prescribed accumulation amount, and when the means for storing reaches the prescribed accumulation amount, to stop the scanning, and when available capacity in the means for storing recovers by progress of the network printing process, to restart the scanning, and after an end of the network printing process, to output the accumulated scanned image data from the first port via the network to the image output device.

11. An image processing system comprising:
an image scanning device that outputs via a network, scanned image information obtained by scanning an image of an original document;
an image output device that visibly outputs remote image information input from a remote device;
an information processing device that accepts an input of the scanned image information from the image scanning device and that outputs the scanned image information to the image output device; and
means for connecting the image scanning device, the image output device and the information processing device to the network so that data can be exchanged,
wherein the image scanning device comprises:
a first port for connecting the image output device;
a second port for connecting the information processing device; and
means for controlling to output from the first port via the network to the image output device, print data received from the network through the second port in a network printing process, and when a copying instruction is input during the network printing process, to scan an image and to accumulate scanned image data until a means for storing reaches a prescribed accumulation amount, and when the imeans for storing reaches the prescribed accumulation amount, to decrease a scanning speed, and when an available capacity in the means for storing recovers by progress of the network printing process, to increase the scanning speed, and after an end of the network printing process, to output the accumulated scanned image data from the first port via the network to the image output device.

12. An image scanning device comprising:
means for outputting via a network, scanned image information obtained by scanning an image of an original document;
a first port for connecting an image output device;
a second port for connecting an information processing device; and
means for controlling to output the scanned image information from the first port via the network to the image output device in a copying process, and when receiving a network printing request from the network through the second port during the copying process, to receive and accumulate print data until a means for storing reaches a prescribed accumulation amount, and when the means for storing reaches the prescribed accumulation amount, to transmit to the information processing device, data instructing to interrupt or suppress transmission of the print data.

13. An image scanning device comprising:
means for outputting via a network, scanned image information obtained by scanning an image of an original document;
a first port for connecting an image output device;
a second port for connecting an information processing device; and
means for controlling to output from the first port via the network to the image output device, print data received from the network through the second port in a network printing process, and when a copying instruction is input during the network printing process, to scan an image and to accumulate scanned image data until a means for storing reaches a prescribed accumulation amount, and when the means for storing reaches the prescribed accumulation amount, to stop the scanning, and when available capacity in the means for storing recovers by progress of the network printing process, to restart the scanning, and after an end of the network printing process, to output the accumulated scanned image data from the first port via the network to the image output device.

14. The image scanning device according to claim 13, further comprising:
an operation unit which includes means for instructing an interrupt copy;
wherein when the interrupt copy is instructed during the network printing process, the means for controlling controls to interrupt the network printing process and to execute a copying process.

15. The image scanning device according to claim 13, wherein the means for controlling comprises:
means for setting to execute one of the copying process and the network printing process preferentially;
wherein when there is a conflict of the copying process and the network printing process, a process set to be carried out preferentially by the means for setting is executed preferentially.

16. An image scanning device comprising:
means for outputting via a network, scanned image information obtained by scanning an image of an original document;
a first port for connecting an image output device;
a second port for connecting an information processing device; and
means for controlling to output from the first port via the network to the image output device, print data received from the network through the second port in a network printing process, and when a copying instruction is input during the network printing process, to scan an image and to accumulate scanned image data until a means for storing reaches a prescribed accumulation amount, and when the means for storing reaches the prescribed accumulation amount, to decrease a scanning speed, and when available capacity in the means for storing recovers by progress of the network printing process, to increase the scanning speed, and after an end of the network printing process, to output the accumulated scanned image data from the first port via the network to the image output device.

17. The image scanning device according to claim 16, further comprising:
an operation unit which includes means for instructing an interrupt copy;
wherein when the interrupt copy is instructed during the network printing process, the means for controlling controls to interrupt the network printing process and to execute a copying process.

18. The image scanning device according to claim 16, wherein the means for controlling comprises:
means for setting to execute one of the copying process and the network printing process preferentially;
wherein when there is a conflict of the copying process and the network printing process, a process set to be carried out preferentially by the means for setting is executed preferentially.

19. The image processing system according to claim 1, further comprising a memory.

20. An image processing system comprising:
an image scanning device that outputs via a network, scanned image information obtained by scanning an image of an original document;
an image output device that visibly outputs remote image information input from a remote device;
an information processing device that accepts an input of the scanned image information from the image scanning device and that outputs the scanned image information to the image output device; and
a hub that connects the image scanning device, the image output device and the information processing device to the network so that data can be exchanged by a common protocol;
wherein the image scanning device comprises:
a port for connecting the image output device;
a port for connecting the information processing device; and
a controller that analyzes destination information of data input from the ports and switches connections of the ports in accordance with the destination information.
